(19) United States
(12) Patent Application Publication
(10) Pub. No.: US 2022/0343396 A1
(43) Pub. Date: Oct. 27, 2022

(54) MIDDLEWARE AS A SERVICE FOR AUTOMATED SUBMISSION VIA A DIGITAL DOCUMENT ADD-IN

(71) Applicant: Nataraj Gangadharappa, frisco, TX (US)

(72) Inventor: Nataraj Gangadharappa, frisco, TX (US)

(21) Appl. No.: 17/532,614

(22) Filed: Nov. 22, 2021

Related U.S. Application Data
(60) Provisional application No. 63/179,544, filed on Apr. 26, 2021.

(51) Int. Cl. G06Q 30/06; G06Q 10/08

(52) U.S. Cl. CPC G06Q 30/0635; G06Q 30/0603; G06Q 30/0641; G06Q 10/0875

(57) ABSTRACT

A computerized method for implementing a middleware as a service for automated submission via a digital document add-in, including the step of providing a buyer organization system comprising one or more buyer organization system servers. The method includes providing a supplier system comprising one or more supplier system servers. The method includes providing an add-in architecture, wherein the add-in architecture pulls master data and stores in database hosted in Middleware as a Service (MWaaS) cloud environment. The method includes purchasing a good and a service with the buyer organization system from supplier system. The supplier system is on boarded in a buyer's procurement application; providing a buyer organization system a key with an add in architecture. The buyer organization system provided key is provided to the supplier system. The key enables the supplier system to post digital invoices via the add in. The method includes, with the supplier system, installing the add in using key provided by buyer to post invoices to buyer buyer's account via the add-in architecture. The supplier searches purchase order created by the buyer for the supplier to submit invoice. The method includes, with add-in architecture returning a set of purchase order details. The method includes enabling the supplier to submit invoice against the purchase order. With an add-in architecture, the method include submitting the invoices in buyer's procurement solution.

### CLAIM OF PRIORITY

This application claims priority to U.S. Provisional Patent Application No. 63/179,544, filed on 26 Apr. 2021 and titled METHODS AND SYSTEMS FOR AN AI-SPACE HOST. This provisional patent application is incorporated herein by reference in its entirety.

### FIELD OF INVENTION

This application related to middleware as a service and more specifically to middleware as a service for automated submission via a digital document add-in.

### BACKGROUND

Invoicing has become increasing complex for enterprises. Additionally, many enterprises utilize various a family of client software, server software, and services on a subscription basis (e.g. Microsoft 365 Office). The client software can be updated with add-in programs. These functionality can be leveraged with an add-in to procurement application of the enterprise. Users (e.g. suppliers) can install add-in into a Microsoft office 365 software. Accordingly, improvements are desired to enable users to submit invoices once the add-in is installed.

### SUMMARY OF THE INVENTION

A computerized method for implementing a middleware as a service for automated submission via a digital document add-in, including the step of providing a buyer organization system comprising one or more buyer organization system servers. The method includes providing a supplier system comprising one or more supplier system servers. The method includes providing an add-in architecture, wherein the add-in architecture pulls master data and stores in database hosted in Middleware as a Service (MWaaS) cloud environment. The method includes purchasing a good and a service with the buyer organization system from supplier system. The supplier system is on boarded in a buyer's procurement application; providing a buyer organization system a key with an add in architecture. The buyer organization system provided key is provided to the supplier system. The key enables the supplier system to post digital invoices via the add in. The method includes, with the supplier system, installing the add in using key provided by buyer to post invoices to buyer buyer's account via the add-in architecture. The supplier searches purchase order created by the buyer for the supplier to submit invoice. The method includes, with add-in architecture returning a set of purchase order details. The method includes enabling the supplier to submit invoice against the purchase order. With an add-in architecture, the method include submitting the invoices in buyer's procurement solution.

### BRIEF DESCRIPTION OF THE DRAWINGS

FIG. 1 illustrates an example system solving for vendor data abuse, according to some embodiments.

FIG. 2 illustrates an example buyer system, according to some embodiments.

FIG. 3 illustrates an example supplier system, according to some embodiments.

FIG. 4 illustrates an example MWaaS manager, according to some embodiments.

FIG. 5 illustrates an example process for implementing an add-in architecture, according to some embodiments.

FIG. 5 illustrates an example process for implementing an add-in architecture, according to some embodiments.

FIG. 6 illustrates an example process for posting invoices for purchase order, according to some embodiments.

FIG. 7 illustrates an example MWaaS manager system, according to some embodiments.

FIG. 8 illustrates an example add in architecture process, according to some embodiments.

FIG. 9 illustrates an example invoice submission process, according to some embodiments.

FIG. 10 illustrates an example system for implementing an add-in architecture, according to some embodiments.

FIG. 11 illustrates another logical view for implementing an add-in architecture as system, according to some embodiments.

The Figures described above are a representative set and are not exhaustive with respect to embodying the invention.

### DESCRIPTION

Disclosed are a system, method, and article for submitting an invoice from an add-in to a procurement application. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’‘an embodiment,’‘one example,’ or similar language means that a particular feature, structure, or characteristic described in connection with the embodiment is included in at least one embodiment of the present invention. Thus, appearances of the phrases ‘in one embodiment,’‘in an embodiment,’and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can be a computing interface that defines interactions between multiple software intermediaries. An API can define the types of calls and/or requests that can be made, how to make them, the data formats that should be used, the conventions to follow, etc. An API can also provide extension mechanisms so that users can extend existing functionality in various ways and to varying degrees.

Cloud computing is the on-demand availability of computer system resources, especially data storage (e.g. cloud storage) and computing power, without direct active management by the user.

E-procurement is the business-to-business or business-to-consumer or business-to-government purchase and sale of supplies, work, and services through the Internet as well as other information and networking systems, such as electronic data interchange and enterprise resource planning. The e-procurement value chain consists of indent management, e-Informing, e-Tendering, e-Auctioning, vendor management, catalogue management, Purchase Order Integration, Order Status, Ship Notice, e-invoicing, e-payment, and contract management. Elements of e-procurement include request for information, request for proposal, request for quotation, RFx (the previous three together), and/or eRFx (software for managing RFx projects).

JSON (JavaScript Object Notation) is an open standard file format and data interchange format that uses human-readable text to store and transmit data objects consisting of attribute—value pairs and arrays (and/or other serializable values).

Machine learning (ML) can use statistical techniques to give computers the ability to learn and progressively improve performance on a specific task with data, without being explicitly programmed. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alio: decision tree learning, association rule learning, artificial neural networks, inductive logic programming, support vector machines, clustering, Bayesian networks, reinforcement learning, representation learning, similarity, and metric learning, and/or sparse dictionary learning.

Key can be a piece of information (e.g. a string of numbers or letters, etc.) that are stored in a file, which, when processed through a cryptographic algorithm, can encode, or decode cryptographic data.

Microsoft Azure® is a cloud-computing service created by Microsoft® for building, testing, deploying, and managing applications and services through managed data centers.

Middleware as a Service (MWaaS) is a software distribution model in which the programming that connects network-based requests generated by a client to the back-end data the client is requesting is offered as a cloud-based service, rather than as an on-premise solution.

Software as a service (SaaS) is a software licensing and delivery model in which software is licensed on a subscription basis and is centrally hosted.

Extensible Markup Language (XML) is a markup language that defines a set of rules for encoding documents in a format that is both human-readable and machine-readable.

### EXAMPLE SYSTEMS AND METHODS

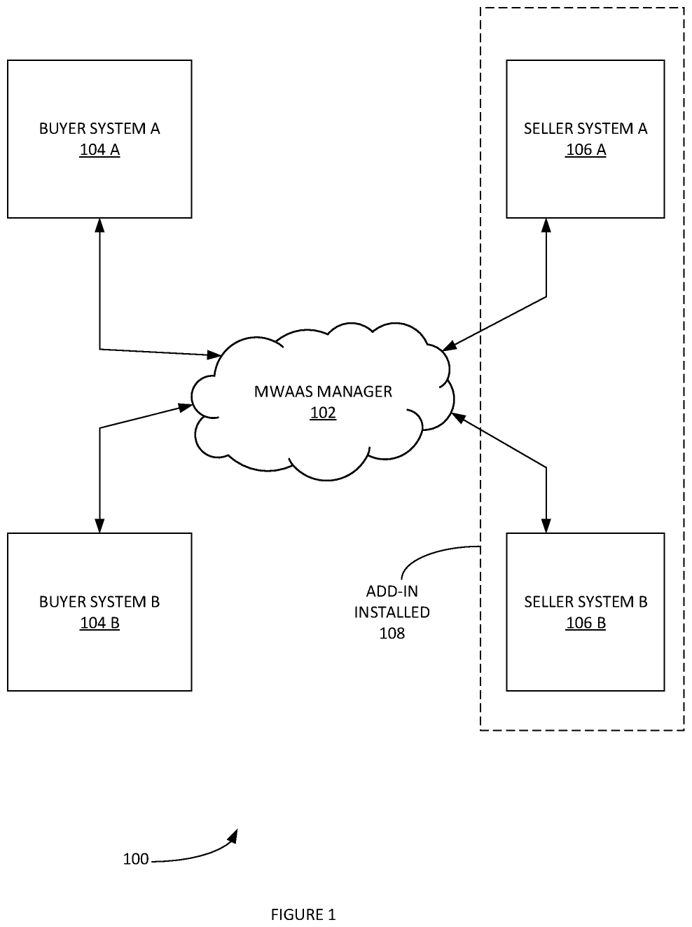

FIG. 1 illustrates an example system 100 solving for vendor data abuse, according to some embodiments. In one exemplary embodiment, system 100 includes the steps to determine submit invoice (e.g. from Microsoft-based software add-in) to a procurement application of an organization. The authorized users (e.g. suppliers 106 A-B, 306, etc.) can install add-in into a Microsoft Office 365° software functionality. The users can submit the invoice once the add-in is installed. The add-in determines whether user has permission to submits invoice for registered organization. The add-in pulls a digital purchase order from organization created for the user and allows to submit invoices against that digital purchase order. These steps can be implemented by MWaaS manager 102.

As noted supra, system 100 provides and manages a MWaaS (e.g. using MWaaS manager 102, etc.). System 100 provides a software distribution model in which the programming that connects network-based requests generated by a client to the back-end data the client is requesting is offered as a cloud-based service, rather than as an on-premise solution, system 100 is a cloud-based service that uses cloud-platform (e.g. Microsoft Azure®, etc.) based solution to provide unique solution to post invoices into buyer organizations networks (e.g. buyers 104 A-B, 204, etc.) of any e-Procurement (e.g. such as SAP Ariba®, Coupa's® Cloud Spend Optimization SaaS product, Bassware® system, etc.). System 100 can provide an MWaaS (e.g. using MWaaS manager 102), SaaS, platform as a service (PaaS) and infrastructure as a service (laaS), etc. System 100 can support many various programming languages, tools, and frameworks.

Buyer systems 104 A-B can include any buyer-side computing and data storage systems. More specifically, buyer systems 104 A-B can include various procurement applications and applications for interacting with supplier-side computing systems (e.g. supplier system 106 A-B). Buyer systems 104 A-B can include enterprise servers, data stores (e.g. of users), etc. Buyer systems 104 A-B can include web servers/clients database managers, e-mail servers/clients, etc.

MWaaS manager 102 can include various data stores for the various enterprises that utilizes the add-in. MWaaS manager 102 can include a functionality to automatically managing add-in architecture.

Supplier systems 106 A-B can include any buyer-side computing and data storage systems. More specifically, supplier systems 106 A-B can include various invoice processing applications and applications for interacting with buyer-side computing systems 104 A-B. Supplier system 106 A-B can download the add-in, and thus, include a Microsoft Office 365° add-in (or an add-in for a similar type of software service/suite such as client/server software suite 302). Supplier systems 106 A-B can interface with a digital distribution platform (i.e. an “app store”) (e.g. the Microsoft on-line store®, etc.) to download, install and/or update the portion of the add-in architecture functionality associated with the supplier system 106 A-B. Supplier systems 106 A-B can also include enterprise servers, data stores, etc. Supplier systems 106 A-B can include web servers/clients database managers, e-mail servers/clients, etc.

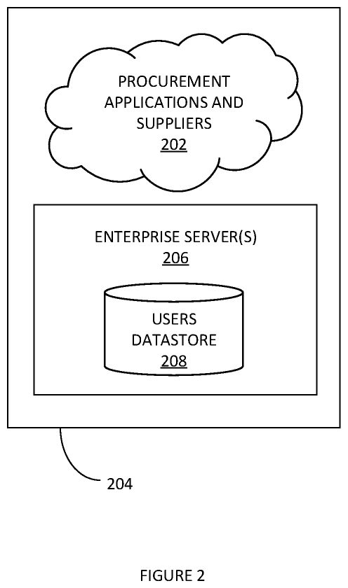

FIG. 2 illustrates an example buyer system 204, according to some embodiments. Buyer system 204 can be an example of a buyer systems 104 A-B. Buyer system 204 can include procurement applications and suppliers 202. Procurement applications and suppliers 202 be used to for automated and online procurement processes for an associated enterprise. Buyer system 204 can include enterprise servers 206. Enterprise servers 206 can include/utilize a database of user(s) 208.

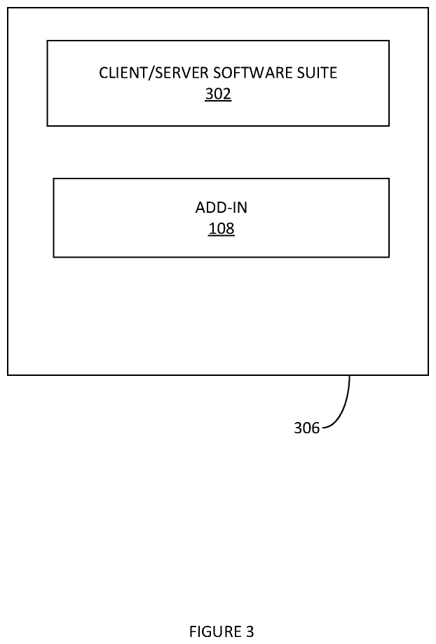

FIG. 3 illustrates an example supplier system 306, according to some embodiments. Supplier system 306 can include client/server software suite 302 (e.g. Microsoft Office 365®, etc.) and an installed add-in 108 for implementing a middleware as a service for automated submission of digital documents (e.g. a digital invoice).

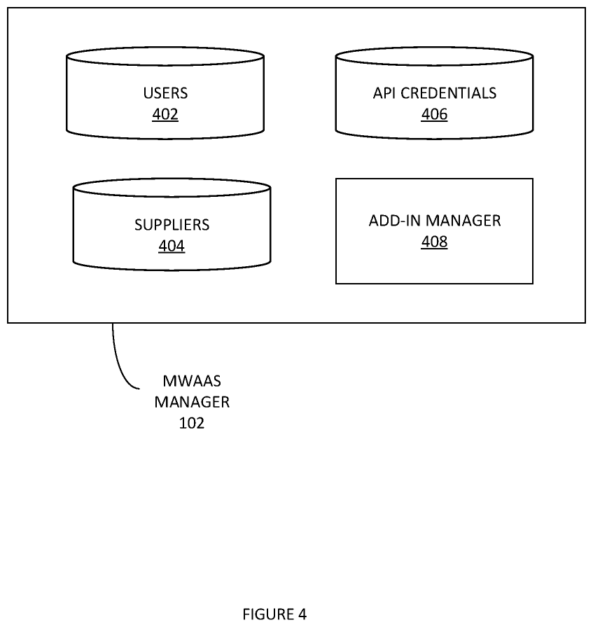

FIG. 4 illustrates an example MWaaS manager 102, according to some embodiments. MWaaS manager 102 can manage the add-in architecture (e.g. the add-in 108, etc.). MWaaS manager 102 can include various relevant datastores (e.g. users datastore 402 API, suppliers datastore 404, credentials datastore 406, etc.) utilized to manage add-in 108.

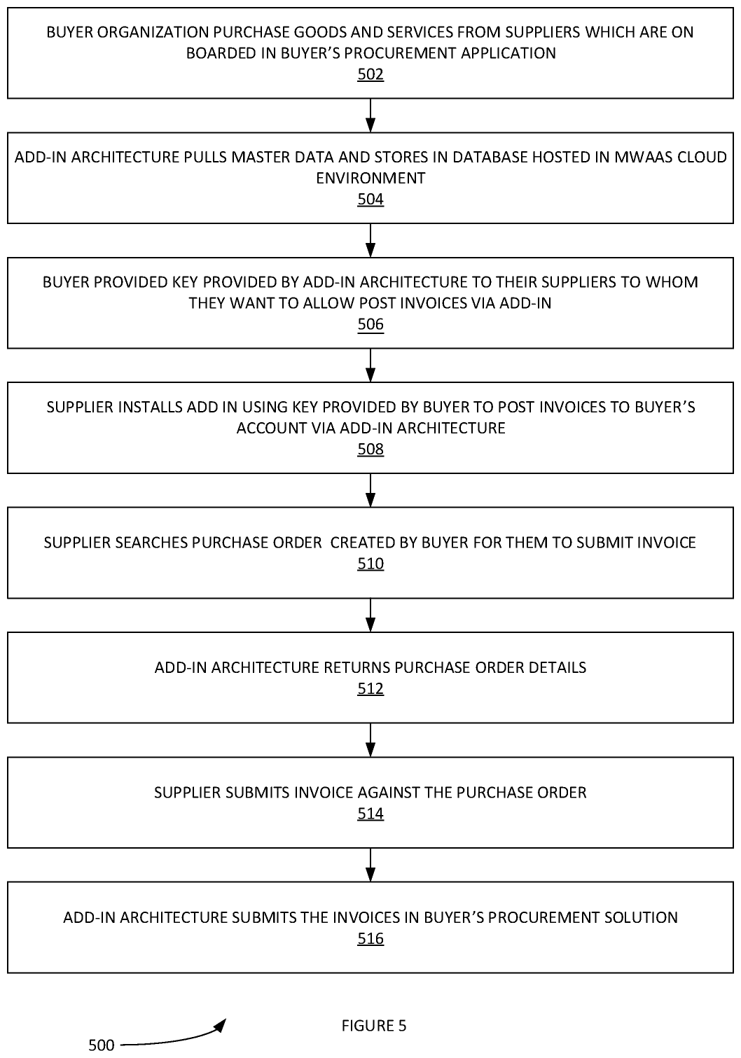

FIG. 5 illustrates an example process 500 for implementing an add-in architecture, according to some embodiments. In step 502, a buyer organization purchase goods and services from suppliers which are on buyer's procurement application. For example, the buyer organization can purchase goods and services from suppliers which are on boarded in the buyer's procurement application. The buyer has to complete registration process with add-in architecture in order to allow their supplier to download. The add-in can be used to post invoices from various client services/server services (e.g. Office 365 documents, etc.) to a user's organization. Process 500 can also leverage any available e-Procurement solutions (e.g. such as SAP Ariba®, Coupa's® Cloud Spend Optimization SaaS product, Bassware® system, etc.). MWaaS manager 102 enables a buyer (e.g. buyer systems A-B 104 A-B, etc.) to setup any additional configuration required by the e-Procurement solution to post invoices to buyer's account.

In step 504, the add-in architecture (e.g. MWaaS manager 102, etc.) pulls the master data and stores it in a database hosted in the MWaaS cloud environment. For example, the add-in architecture pulls master data such as for, inter alia: suppliers 106 A-B, users 104 A-B, API credentials and stores (e.g. users datastore 402 API, suppliers datastore 404, credentials datastore 406) in a database hosted in AI Space host Azure cloud environment. These data stores can be, inter alia: users datastore 402 API, suppliers datastore 404, credentials datastore 406, etc.

In step 506, the buyer (i.e. a buyer computing systems A-B 106 A-B as provided in system 100, etc.) provides a key provided by the add-in architecture (e.g. add-in manager 408, etc.) to their suppliers to whom they want to allow to post invoices via the add-in integrated into the Microsoft Office 365° software system(s) associated with buyer computing systems A-B 106 A-B. For example, the buyer can provide a key provided to a seller (e.g. using MWaaS manager 102) to their suppliers to whom they want to allow post invoices via the Microsoft Office 365° software system(s) Add-in. MWaaS manager 102 (e.g. an AI Space Host, etc.) generates unique key for each supplier for each buyer.

In step 508, the supplier (i.e. a supplier computing system as provided in system 100, etc.) installs the add-in using the key provided by buyer to post invoices to buyer buyer's account via add-in architecture. For example, the supplier can install Microsoft Office 365° software system(s) add-in using the key provided by the buyer to post invoices to the buyer's account via the MWaaS manager 102 (e.g. using add-in manager 408, etc.).

In step 510, the supplier digitally searches purchase order (PO) created by the buyer for them to submit digital invoice.

In step 512, the add-in architecture returns PO details.

In step 514, the supplier submits invoice against the PO. This can be performed using a PO flip. A PO flip happens when a PO invoice is created digitally. A supplier can convert a PO into an invoice and send it to the buyer who created the PO using an automated tool(s).

The step 516, the MWaaS manager 102 uses the add-in architecture to submit the invoices in buyer buyer's e-Procurement solution.

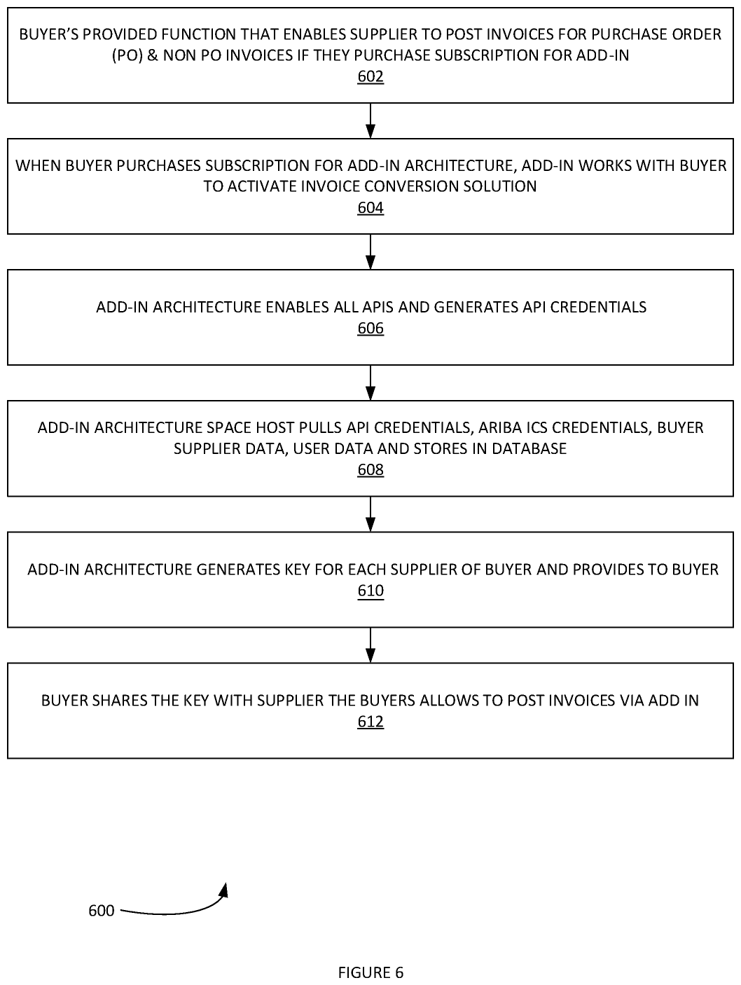

FIG. 6 illustrates an example process 600 for posting invoices for purchase order, according to some embodiments. In step 602, process 600 provides a buyer's provided function. The buyer's provided function enables supplier to post invoices for purchase order (PO) and non-purchase order invoices if they purchase subscription for add in. In step 604, process determines that when a buyer purchases subscription for add in architecture, the add in then works with buyer to activate invoice conversion solution. In step 606, the add in architecture enables all APIs and generates API credentials. In step 608, the add in architecture space host pulls API credentials, Ariba ICS credentials, buyer supplier data, user data and stores in database. In step 610, the add in architecture generates key for each supplier of buyer and provides to buyer. In step 612, the buyer shares the key with supplier the buyers allows to post invoices via add in.

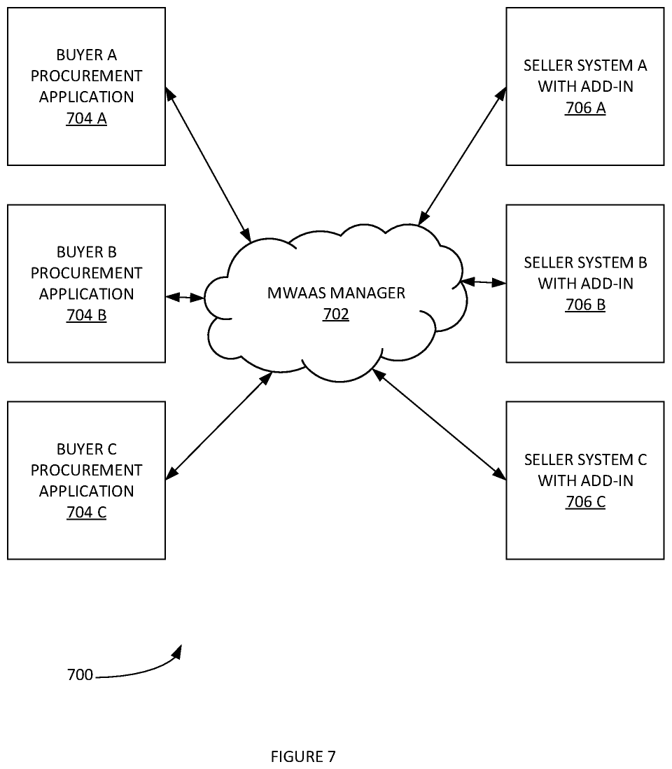

FIG. 7 illustrates an example MWaaS manager system 700, according to some embodiments. MWaaS manager system 700 includes MWaaS manager 702. MWaaS manager system 700 can manage a data flow of the add in lip invoice. MWaaS manager system 700 can include buyer A-C procurement applications 704 A-C. MWaaS manager system 700 can include seller systems A-C with add ins 706 A-C.

MWaaS manager system 700 can manage a data flow of the add in flip invoice. MWaaS manger 702 can receive a PO request from seller systems A-C with add ins 706 A-C. MWaaS manger 702 can forward the PO request to buyer A-C procurement applications 704 A-C to pull the PO data. Buyer A-C procurement applications 704 A-C can forward the PO data to MWaaS manager 702 where it is then formatted. The PO formatted data is then sent to seller systems A-C with add ins 706 A-C.

MWaaS manager 702 an manage invoice submissions as well. MWaaS manger 702 can receive a PO request from seller systems A-C with add ins 706 A-C. MWaaS manger 702 can forward the PO request to buyer A-C procurement applications 704 A-C to pull the PO data. Buyer A-C procurement applications 704 A-C can forward the PO data to MWaaS manager 702 where it is then formatted. The PO formatted data is then sent to seller systems A-C with add ins 706 A-C. Seller systems A-C with add ins 706 A-C can then invoice against the PO. MWaaS manager 702 send the invoice to buyer A-C procurement applications 704 A-C(e.g. in an XML formant or the like).

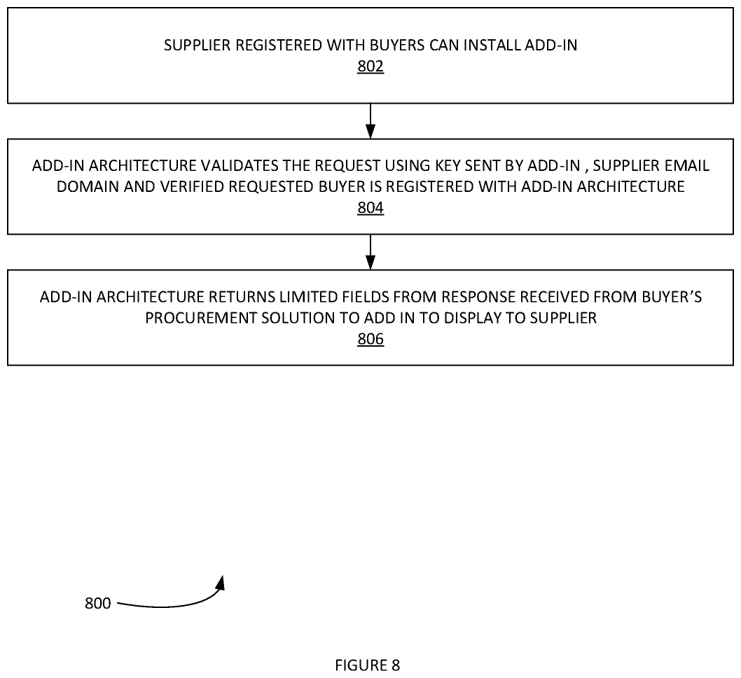

FIG. 8 illustrates an example add in architecture process 800, according to some embodiments. In step 802, a supplier registered with buyers can install add in. In step 804, the add in architecture validates the request using key sent by add in, supplier email domain and verified requested buyer is registered with add in architecture. In step 806, the add in architecture returns limited fields from response received from buyer buyer's procurement solution to add in to display to supplier.

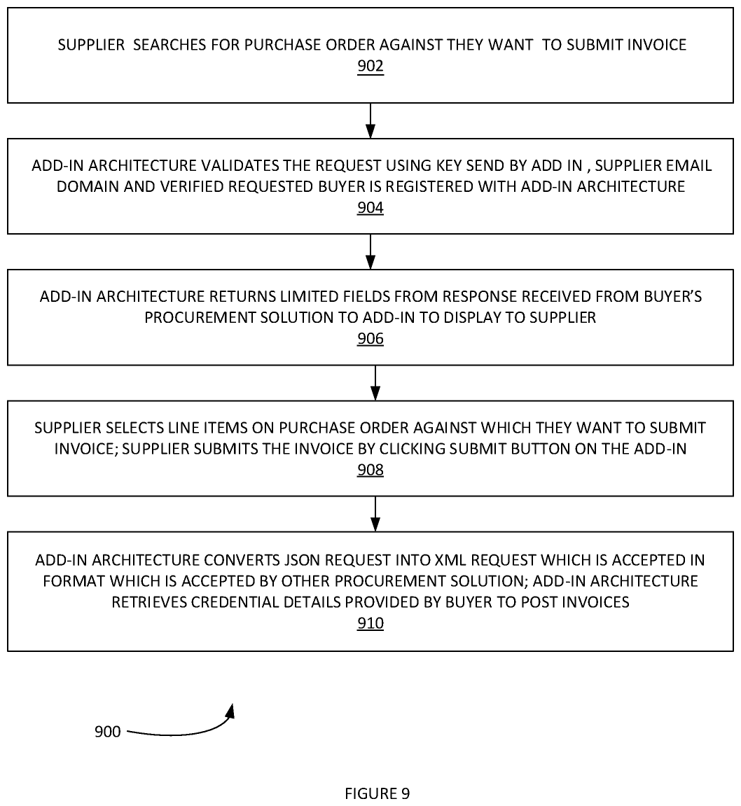

FIG. 9 illustrates an example invoice submission process 900, according to some embodiments. In step 902, the supplier searches for purchase order against they want to submit invoice. In step 904, the add-in architecture validates the request using key send by add in, supplier email domain and verified requested buyer is registered with add add-in architecture. In step 906, the add-in architecture returns limited fields from response received from buyer buyer's procurement solution to add add-in to display to supplier. In step 908, the supplier selects line items on purchase order against which they want to submit invoice; and supplier submits the invoice by clicking submit button on the add add-in. In step 910, the add-in architecture converts JSON request into XML request which is accepted in format which is accepted by other procurement solution; and add add-in architecture retrieves credential details provided by buyer to post invoices.

### ADDITIONAL SYSTEMS

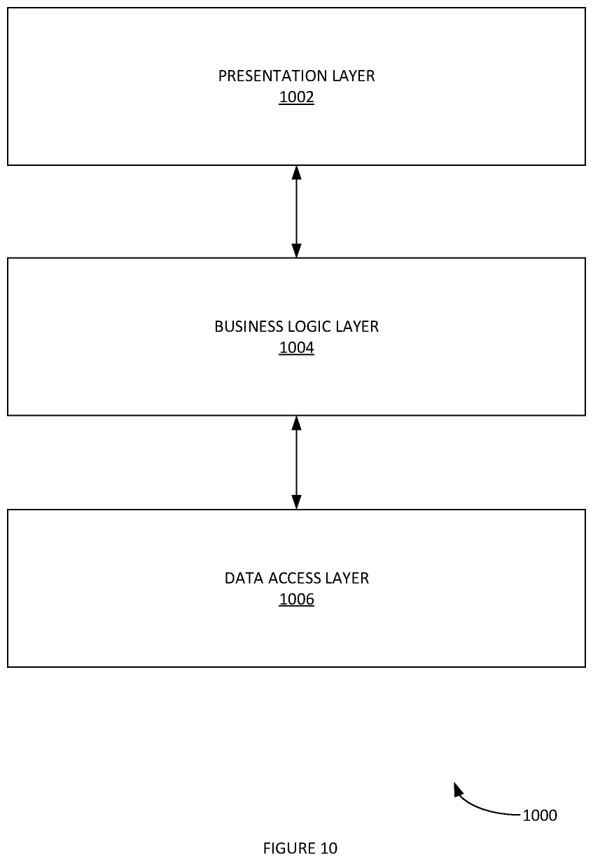

FIG. 10 illustrates an example system 1000 for implementing an add-in architecture, according to some embodiments. System 1000 includes presentation layer 1002, business layer 1004, and data-access layer 1006. This can be a three-tiered architecture as shown. In one example, system 1000 can be a Microsoft® (MS) Outlook® flip invoice add inn architecture. An invoice add in can enable a user to search for invoices and submit them right from their Outlook® and/or similar application. The add in works seamlessly with the organization's existing Outlook client desktop or web-based system. Outlook® add ins add extensions used in Microsoft Office® including, inter alia: being cross platform, work on Web, Windows, Mac, iPad, and other device form factors; enable centralized offers for deployment and distribution, which administrators can take advantage of to distribute the add in in an organization; and provide an easy access (e.g. via AppSource®, Microsoft Store®, etc.).

More specifically, system 1000 can be used for implementing a flip invoice add inn architecture. As noted, system 1000 includes a data access layer 1006. Data access layer 1006 can be a NoSQL DB is used to store the data elements of the application. System 1100 includes a data access layer 1004. In business logic layer 1004 can be a stateless server serves the presentation layer 1002 with responses. NodeJS can be used to serve the business responses to the presentation layer 1002. In the Presentation layer 1002, Angular and/or Bootstrap frameworks can be used to deliver a platform agnostic user interface.

Security is built into the product end. System 1000 can include various security features in the add in. System 1000 can include security at rest. Data access layer 1004 can be protected by serverless functions and API authentication registered by buyer. Security in transit can be provided in that the data is end-to-end encrypted between presentation layer 1002 and business logic layers 1006. Users can be authenticated by the enterprise while using the Outlook365 interface via the Enterprise SSO based systems. Users can edit, submit, and/or view the purchase orders.

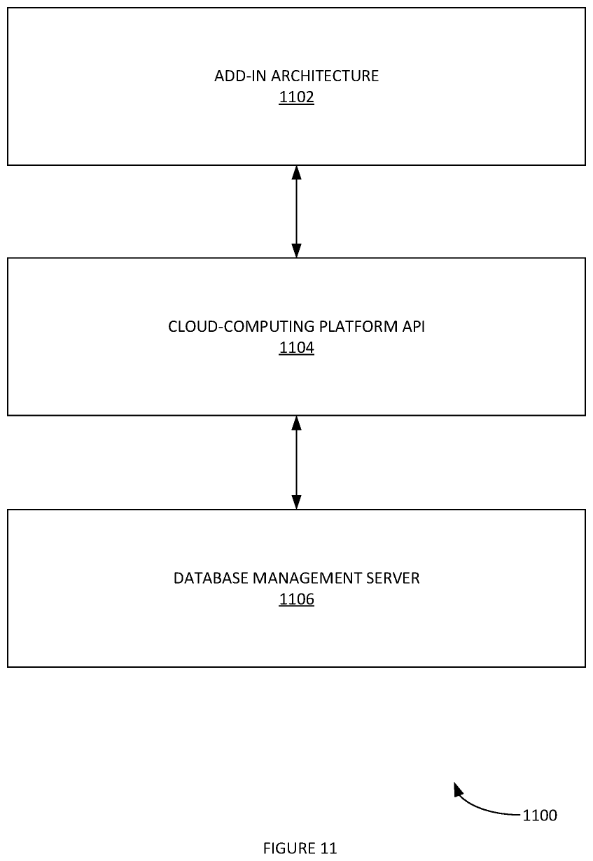

FIG. 11 illustrates another logical view for implementing an add-in architecture as system 1100, according to some embodiments. System 1100 include add in architecture 1102, cloud computing platform API 1104, database management server 1106. In one example, add in architecture 1102 can be a MS Outlook 365° architecture. In one example, cloud computing platform API 1104 can be an MS Azure® API. In one example, database management server 1106 can be an SQL server system.

It is noted that MS Azure Functions can be performed event driven serverless compute platform that can also solve complex orchestration problems. The functions can be built and debugged locally with no additional setup on your existing development environment, deploy and operate at scale in the cloud, and integrate service using triggers and bindings. MS Azure functions can be used as extensions and templates on Visual Studio and Visual Studio Code for a faster and more efficient development on your local machine, fully integrated with the whole MS Azure platform. The MS Azure functions also monitor and Analyze code performance with Azure Application Insight. MS Azure functions can spot bottlenecks and failure hotspots across all components of your application using application maps with distributed tracing from Azure Monitor. MS Azure functions can isolate networks through virtual network connectivity on the Functions premium plan, enabling outbound traffic into a secured virtual network gating incoming traffic and defining app restrictions. MS Azure functions can grant access to application using built in authentication with Azure Active Directory, Microsoft account, etc. The buyer supplier details business Azure Function accept input in JSON using get/post method to return buyer supplier details computing from various Azure API services as per business logic. MS Azure functions can return requested purchase orders details in JSON format.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized method for implementing a middleware as a service for automated submission via a digital document add-in, comprising:
providing a buyer organization system comprising one or more buyer organization system servers;
providing a supplier system comprising one or more supplier system servers;
providing an add-in architecture, wherein the add-in architecture pulls master data and stores in database hosted in Middleware as a Service (MWaaS) cloud environment;
purchasing a good and a service with the buyer organization system from supplier system, wherein the supplier system is on boarded in a buyer's procurement application;
providing a buyer organization system a key with an add in architecture, wherein the buyer organization system provided key is provided to the supplier system, wherein the key enables the supplier system to post digital invoices via the add in;
with the supplier system, installing the add in using key provided by buyer to post invoices to buyer buyer's account via the add-in architecture;
wherein the supplier searches purchase order created by the buyer for the supplier to submit invoice;
with add-in architecture returning a set of purchase order details;
enabling the supplier to submit invoice against the purchase order; and
with an add-in architecture, submitting the invoices in buyer's procurement solution.

2. The computerized method of claim 1, wherein an e-Procurement functionality is provided enable a configuration of the one or more buyer organization system servers for the posting of a digital invoice to a buyer's account.

3. The computerized method of claim 2, wherein the MWaaS cloud environment provides an application programming interface (API) that receives an API credential.

4. The computerized method of claim 3, wherein the wherein the MWaaS cloud environment hosts a set of data stores comprising supplier system data, digital invoice data, and buyer organization system.

5. The computerized method of claim 4, wherein the buyer system using MWaaS manager.

6. A computerized system for implementing a middleware as a service for automated submission via a digital document add-in comprising:
at least one processor configured to execute instructions;
a memory containing instructions when executed on the processor, causes the at least one processor to perform operations that:
provide a buyer organization system comprising one or more buyer organization system servers;
provide a supplier system comprising one or more supplier system servers;
provide an add-in architecture, wherein the add-in architecture pulls master data and stores in database hosted in Middleware as a Service (MWaaS) cloud environment;
purchase a good and a service with the buyer organization system from supplier system, wherein the supplier system is on boarded in a buyer's procurement application;
provide a buyer organization system a key with an add in architecture, wherein the buyer organization system provided key is provided to the supplier system, wherein the key enables the supplier system to post digital invoices via the add in;
with the supplier system, install the add in using key provided by buyer to post invoices to buyer buyer's account via the add-in architecture, wherein the supplier searches purchase order created by the buyer for the supplier to submit invoice;
with add-in architecture return a set of purchase order details;
enable the supplier to submit invoice against the purchase order; and
with an add-in architecture, submit the invoices in buyer's procurement solution.

7. The computerized system of claim 6, wherein an e-Procurement functionality is provided enable a configuration of the one or more buyer organization system servers for the posting of a digital invoice to a buyer's account.

8. The computerized system of claim 7, wherein the MWaaS cloud environment provides an application programming interface (API) that receives an API credential.

9. The computerized system of claim 8, wherein the wherein the MWaaS cloud environment hosts a set of data stores comprising supplier system data, digital invoice data, and buyer organization system.

10. The computerized system of claim 9, wherein the buyer system using MWaaS manager.
